(19) United States
(12) Patent Application Publication
(10) Pub. No.: US 2016/0301855 A1
(43) Pub. Date: Oct. 13, 2016

(54) IMAGING DEVICE AND PHASE DIFFERENCE DETECTION METHOD

(71) Applicant: OLYMPUS CORPORATION, Tokyo (JP)

(72) Inventor: Shinichi IMADE, Iruma-shi (JP)

(73) Assignee: OLYMPUS CORPORATION, Tokyo (JP)

(21) Appl. No.: 15/093,884

(22) Filed: Apr. 8, 2016

Related U.S. Application Data
(63) Continuation of application No. PCT/JP2014/070304, filed on Aug. 1, 2014.

(30) Foreign Application Priority Data
Oct. 23, 2013 (JP) 2013-220022

(51) Int. Cl. H04N 5/232; H04N 13/02; H04N 9/04

(52) U.S. Cl. CPC H04N 5/23212; H04N 9/045; H04N 13/0257; H04N 13/0225

(57) ABSTRACT

An imaging device includes an imager, and a processor including hardware. The imager includes an optical low-pass filter that has a cut-off frequency equal to or lower than 1/(2P) when the pitch of the pixels that are used to capture a first object image and a second object image are P. The processor is configured to implement the densification process that includes performing an upsampling process on a first image in which the first object image is captured and a second image in which the second object image is captured, and performing a two-dimensional low-pass filtering process on the first image and the second image that have been subjected to the upsampling process, and a phase difference detection process that detects the phase difference between the first image and the second image that have been subjected to the densification process.

### CROSS REFERENCE TO RELATED APPLICATION

This application is a continuation of International Patent Application No. PCT/JP2014/070304, having an international filing date of Aug. 1, 2014, which designated the United States, the entirety of which is incorporated herein by reference. Japanese Patent Application No. 2013-220022 filed on Oct. 23, 2013 is also incorporated herein by reference in its entirety.

### BACKGROUND

The present invention relates to an imaging device, a phase difference detection method, and the like.

In recent years, an increase in the autofocus (AF) speed of a digital camera has progressed. An improvement in a real-time 3D measurement process and a further improvement in measurement accuracy have been desired for a microscope, an endoscope, and the like. These imaging devices are normally designed to capture an image utilizing an image sensor in view of digitalization, and an image measurement process that directly utilizes the captured image (i.e., that does not utilize a measurement detection section that is separately provided) is widely used.

A method that utilizes a phase difference is widely used for an AF process or a 3D measurement process. The method that utilizes a phase difference basically acquires two parallax images, and detects the phase difference (shift amount) between the parallax images to calculate the distance from the imaging system to the object using the principle of triangulation. When detecting the phase difference, a correlation calculation process or the like is performed while moving one of the parallax images from the initial position relative to the other parallax image, the similarity between the parallax images is evaluated by the correlation calculation process to determine the matching position, and the difference between the initial position and the matching position is detected as the phase difference. A binocular stereoscopic method that utilizes two cameras placed at a given interval has been used from a long time ago as a method for obtaining parallax images. In recent years, a monocular method that can be achieved using a simple configuration has been proposed. For example, a method that separates light that has passed through one of the pupils of the imaging lens and light that has passed through the other pupil of the imaging lens to form different pupil images to obtain parallax images has been proposed.

According to the monocular method, images that have respectively passed through two pupils are captured by one image sensor. For example, JP-A-2009-145401 discloses a method that uses two adjacent pixels in the image sensor plane as a pair of pixels, and separates a pixel on which light that has passed through one of the pupils is incident and a pixel on which light that has passed through the other pupil is incident based on the incident angle as a method for forming (separating) two pupil images from the captured image. Since the pixel in which one of the pupil images is sampled and the pixel in which the other pupil image is sampled can be obtained as separate components, it is possible to detect the phase difference.

For example, JP-A-2001-174696 discloses a method that provides a spectral filter at the pupil position of the imaging optical system instead of the image sensor plane. For example, a red image that has passed through one of the pupils and a blue image that has passed through the other pupil are formed in the image sensor plane. One of the pupil images is acquired using the red pixels of the image sensor, and the other pupil image is acquired by using the blue pixels of the image sensor.

When using the binocular method and the monocular method, two parallax images correspond to the waveform data of the images sampled using the pixels of the image sensor, and a matching calculation process is performed on the waveform data to detect the phase difference.

### SUMMARY

According to one aspect of the invention, there is provided an imaging device comprising:

an imager that captures a first object image and a second object image that have parallax with respect to an identical object; and

a processor comprising hardware,

the processor being configured to implement:

a densification process that is performed on a first image and a second image, the first image being an image in which the first object image is captured, and the second image being an image in which the second object image is captured; and

a phase difference detection process that detects a phase difference between the first image and the second image that have been subjected to the densification process,

wherein the imager includes an optical low-pass filter that has a cut-off frequency equal to or lower than 1/(2P) when a pitch of pixels that are used to capture the first object image and a pitch of pixels that are used to capture the second object image are P, and

the processor is configured to implement the densification process that includes performing an upsampling process on the first image and the second image, and performing a two-dimensional low-pass filtering process on the first image and the second image that have been subjected to the upsampling process.

According to another aspect of the invention, there is provided a phase difference detection method comprising:

capturing a first object image and a second object image that have parallax with respect to an identical object, the first object image and the second object image having passed through an optical low-pass filter having a cut-off frequency equal to or lower than 1/(2p) when a pitch of pixels that are used to capture the first object image and a pitch of pixels that are used to capture the second object image are P;

performing an upsampling process on a first image and a second image, the first image being an image in which the first object image is captured, and the second image being an image in which the second object image is captured;

performing a two-dimensional low-pass filtering process on the first image and the second image that have been subjected to the upsampling process; and

detecting a phase difference between the first image and the second image that have been subjected to the two-dimensional low-pass filtering process.

### BRIEF DESCRIPTION OF THE DRAWINGS

FIG. 1 illustrates a configuration example of an imaging device.

FIG. 2 is a view illustrating the basic principle of a stereo image measurement method that utilizes a pupil division technique.

FIG. 3 illustrates a configuration example of an imaging device (first embodiment).

FIG. 4 illustrates an example of the spectral characteristics of a pupil division filter and an image sensor.

FIG. 5 is a view illustrating a densification process (first embodiment).

FIGS. 6A to 6D are views illustrating a densification process (first embodiment).

FIG. 7 is a view illustrating a densification process (first embodiment).

FIGS. 8A to 8C illustrate simulation results for a phase difference detection process using a densification process.

FIG. 9 is a view illustrating a densification process (first embodiment).

FIG. 10 illustrates sampling data similarity simulation results.

FIG. 11 is a view illustrating a densification process (second embodiment).

FIG. 12 is a view illustrating a densification process (second embodiment).

FIG. 13 is a view illustrating an improved SAD matching evaluation process.

FIG. 14 illustrates simulation results for a statistical variance of a phase difference detection value with respect to the SN ratio of waveforms.

### DESCRIPTION OF EXEMPLARY EMBODIMENTS

Several aspects of the invention may provide an imaging device, a phase difference detection method, and the like that can implement a phase difference detection process at a higher resolution with respect to the pixel pitch of an image sensor.

Exemplary embodiments of the invention are described in detail below. Note that the following exemplary embodiments do not in any way limit the scope of the invention defined by the claims laid out herein. Note also that all of the elements described below in connection with the exemplary embodiments should not necessarily be taken as essential elements of the invention.

### 1. Outline

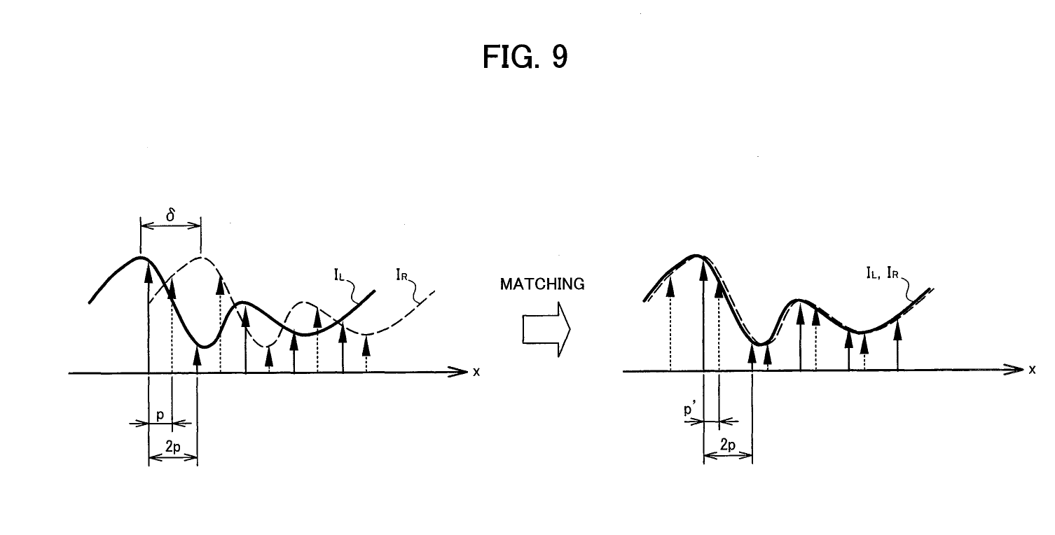

According to a known phase difference detection process (method), the phase difference detection resolution is determined by the density of the sampling pixels that correspond to each parallax image (Le., each of two parallax images) captured using the pupil division technique. Specifically, the waveform pattern of each parallax image is handled as data sampled corresponding to each sampling pixel (see the left side in FIG. 9). When calculating a correlation coefficient while shifting the relative position of two waveform patterns from the initial position, a correlation coefficient is obtained at a relative position at which the sampling positions of the two waveform patterns coincide with each other. Therefore, the matching position detection resolution is determined by the sampling density, and the resolution of the phase difference that is the difference between the initial position and the matching position is also determined by the sampling density.

For example, a case where the phase difference detection process is applied to a ranging process is discussed below. The range resolution Δz is determined by the phase difference detection resolution Δs (as described later with reference to the expression (2)). Specifically, it is necessary to increase the phase difference detection resolution in order to implement a high-resolution ranging process. However, the pixel density of an image sensor has approached the upper limit of the optical resolution, and it is not considered that a significant improvement in pixel density will be achieved in the future. Therefore, it is a great challenge to implement high-density sampling at a sampling density equal to or higher than the pixel density of an image sensor.

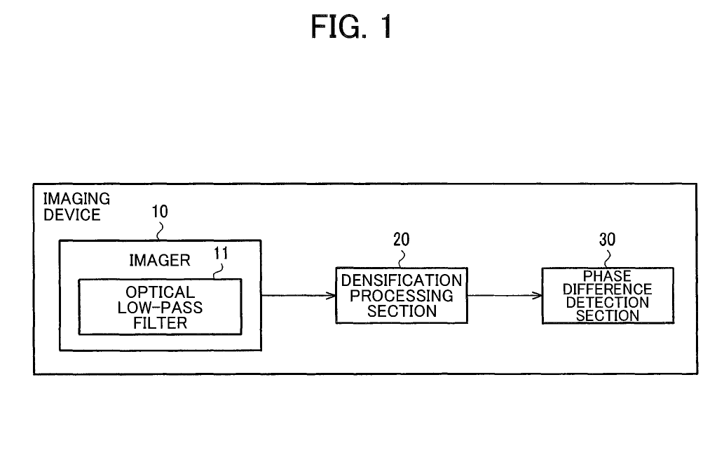

FIG. 1 illustrates a configuration example of an imaging device according to several embodiments of the invention that can solve the above problem. The imaging device includes an imager 10 that captures a first object image and a second object image that have parallax with respect to an identical object, a densification processing section 20 that performs a densification process on a first image and a second image, the first image being an image in which the first object image is captured, and the second image being an image in which the second object image is captured, and a phase difference detection section 30 that detects the phase difference between the first image and the second image that have been subjected to the densification process.

The imager 10 includes an optical low-pass filter 11 that has a cut-off frequency equal to or lower than 1/(2P) when the pitch of the pixels that are used to capture the first object image and the pitch of the pixels that are used to capture the second object image are P. The densification processing section 20 performs the densification process that includes performing an upsampling process on the first image and the second image, and performing a two-dimensional low-pass filtering process on the first image and the second image that have been subjected to the upsampling process.

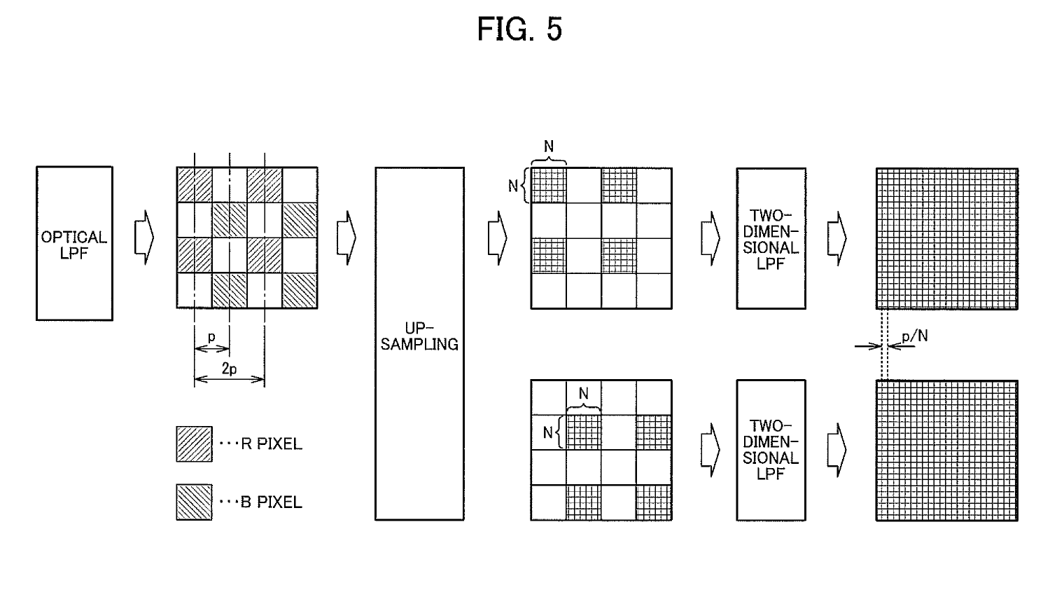

For example, a monocular imaging optical system is subjected to pupil division, and parallax images are acquired using an image sensor having a Bayer array (see the first embodiment described later). The first object image that has passed through the first pupil is captured using the red pixels, and the second object image that has passed through the second pupil is captured using the blue pixels. As illustrated in FIG. 5, the sampling pitch of the first image and the sampling pitch of the second image are P=2p The upsampling process is performed on the first image and the second image to increase the number of pixels of the first image and the number of pixels of the second image by a factor of N×N, and the two-dimensional low-pass filtering process is performed on the first image and the second image. This makes it possible to obtain parallax images having a sampling density (pixel pitch p/N) that is higher than the pixel density (pixel pitch p) of the image sensor by a factor of N.

According to this configuration, it is possible to generate parallax images of which the apparent sampling density is significantly higher than the pixel density of the image sensor. It is possible to implement a phase difference detection process with a significantly improved detection resolution by detecting the phase difference using the resulting parallax images. According to the above example, since the correlation coefficient can be calculated at an N-fold density, it is possible to detect the phase difference at an N-fold resolution.

Although an example that utilizes a monocular imaging optical system (see the first embodiment) has been described above, the embodiments of the invention may also be applied to the case of using a binocular imager. For example, when image sensors are respectively provided to binocular imaging optical systems, the sampling pitch P of each parallax image is the same as the pixel pitch p of the image sensor (i.e., P=p).

The imaging device according to the embodiments of the invention may be configured as described below. Specifically, the imaging device according to the embodiments of the invention includes the imager 10, a memory that stores information (e.g., a program and various types of data), and a processor (i.e., a processor including hardware) that operates based on the information stored in the memory. The processor is configured to implement the densification process that is performed on the first image and the second image, and a phase difference detection process that detects the phase difference between the first image and the second image that have been subjected to the densification process. The imager 10 includes the optical low-pass filter 11. The processor is configured to implement the densification process that includes performing the upsampling process on the first image and the second image, and performing the two-dimensional low-pass filtering process on the first image and the second image that have been subjected to the upsampling process.

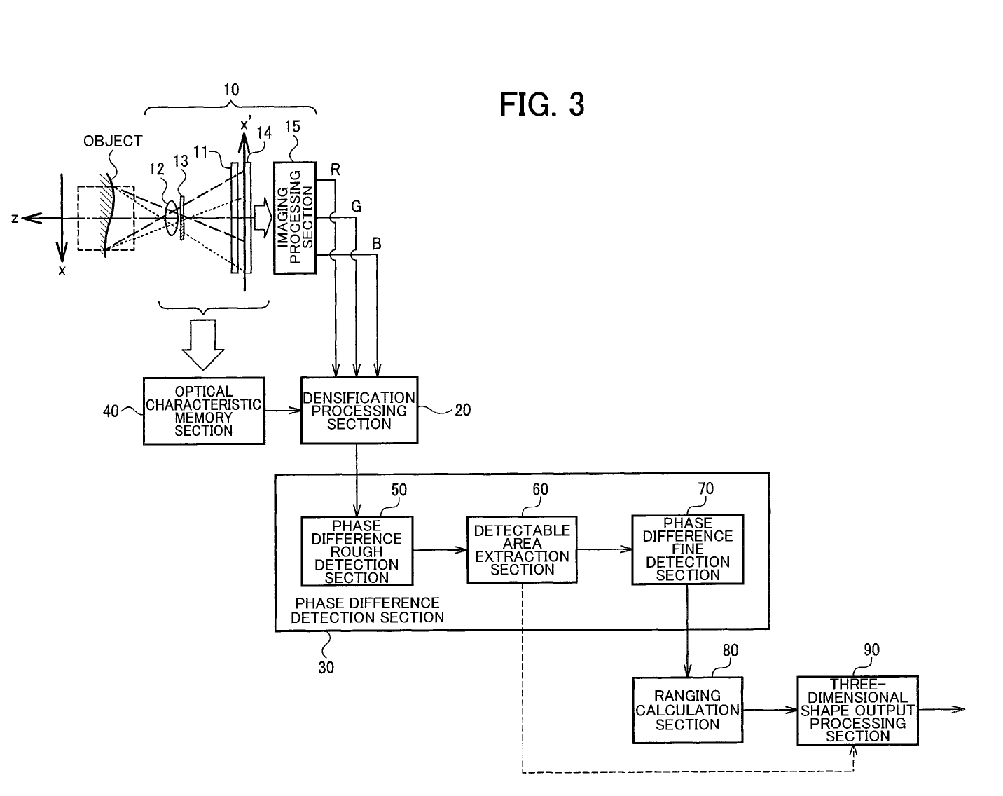

The processor may implement the function of each section by individual hardware, or may implement the function of each section by integrated hardware, for example. The processor may be a central processing unit (CPU), for example. Note that the processor is not limited to a CPU. Various other processors such as a graphics processing unit (GPU) or a digital signal processor (DSP) may also be used. The processor may be a hardware circuit that includes an ASIC. The memory may be a semiconductor memory (e.g., SRAM or DRAM), a register, a magnetic storage device (e.g., hard disk drive), or an optical storage device (e.g., optical disk device). For example, the memory stores a computer-readable instruction, and each section (e.g., densification processing section 20 and phase difference detection section 30 illustrated in FIG. 1, or densification processing section 20, phase difference detection section 30, ranging calculation section 80, and three-dimensional shape output processing section 90 illustrated in FIG. 3) of the imaging device is implemented by causing the processor to execute the instruction. The instruction may be an instruction included in an instruction set that is included in a program, or may be an instruction that causes a hardware circuit included in the processor to operate.

The operation according to the embodiments of the invention is implemented as described below, for example. The first image and the second image captured by the imager 10 are stored in the memory. The processor reads the first image and the second image from the memory, performs the upsampling process on the first image and the second image, and stores the first image and the second image that have been subjected to the upsampling process in the memory. The processor reads the first image and the second image that have been subjected to the upsampling process from the memory, performs the two-dimensional low-pass filtering process on the first image and the second image, and stores the first image and the second image that have been subjected to the two-dimensional low-pass filtering process in the memory. The processor reads the first image and the second image that have been subjected to the two-dimensional low-pass filtering process from the memory, detects the phase difference between the first image and the second image, and stores the phase difference in the memory.

Each section of the imaging device according to the embodiments of the invention is implemented as a module of a program that operates on the processor. For example, the densification processing section 20 is implemented as a densification processing module that performs the densification process on the first image and the second image. Likewise, the phase difference detection section 30 is implemented as a phase difference detection module that detects the phase difference between the first image and the second image that have been subjected to the densification process.

### 2. First Embodiment

### 2.1. Stereo Image Measurement Method

The first embodiment is described below. In the first embodiment, a monocular imager is subjected to pupil division, and different colors are respectively assigned to the two pupils to detect the phase difference to implement a 3D measurement process.

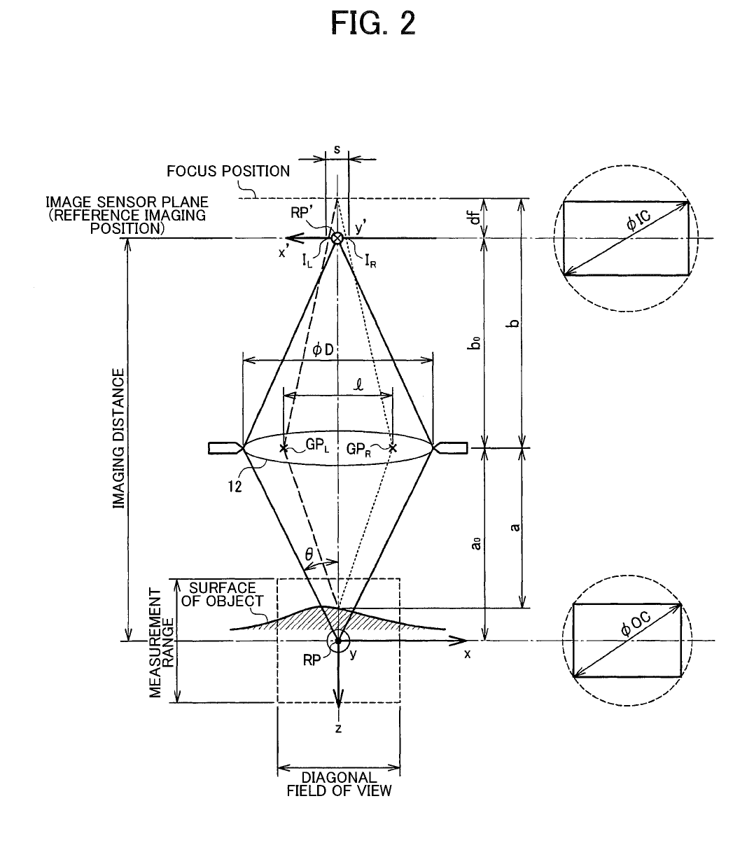

The basic principle of the stereo image measurement method that utilizes the pupil division technique is described below with reference to FIG. 2. Although an example in which the pupil is divided in the rightward-leftward direction (horizontal scan direction) is described below, the pupil need not necessarily be divided in the rightward-leftward direction. It suffices that the pupil be divided in an arbitrary direction that is orthogonal to the optical axis.

Reflected light from the surface of the object passes through an imaging lens 12 (imaging optical system), forms an image in the image sensor plane, and is acquired by the image sensor as an image signal. The coordinate axes when a reference position RP of the object is set to be the origin are referred to as (x, y, z), and the coordinate axes when an in-focus position RP′ in the image sensor plane is set to be the origin are referred to as (x′, y′). For example, the x′-axis corresponds to the horizontal scan direction of the image sensor, and the y′-axis corresponds to the vertical scan direction of the image sensor. The z-axis corresponds to the direction along the optical axis of the imaging lens 12 (i.e., depth distance direction).

The distance from the reference position RP of the object to the center of the imaging lens 12 is referred to as a₀, and the distance from the center of the imaging lens 12 to the image sensor plane is referred to as b₀. The distance a₀ and the distance b₀ are determined by the design of the imager.

The left half of the imaging lens 12 is referred to as a left pupil, and the right half of the imaging lens 12 is referred to as a right pupil. GP_{L} is the center-of-gravity position of the left pupil, and GP_{R} is the center-of-gravity position of the right pupil. An image obtained in the image sensor plane is defocused as the surface of the object moves away from the reference position in the z-direction, and an image I_{L} that has passed through the left pupil and an image I_{R} that has passed through the right pupil (hereinafter referred to as “left-pupil image” and “right-pupil image”, respectively) are shifted from each other (i.e., have a phase difference s). Although FIG. 2 illustrates an example in which the pupil position is situated at the center of the lens for convenience of explanation, the pupil position is present at a position (e.g., aperture) outside the lens in the actual situation.

The relationship between the phase difference s and the position z of the surface of the object is calculated. The relationship between the phase difference s between the left-pupil image I_{L} and the right-pupil image I_{R} obtained in the image sensor plane and the position z of the surface of the object is determined by the following expression (1).

$$s = \frac{- Ml \cdot z}{z + {a}_{0}} \qquad ( 1 )$$

Note that M is the total optical magnification at a reference in-focus position. When the imaging field-of-view circle diameter is φIC, and the field-of-view circle diameter in the imaging range is φOC, M=φIC/φOC=b₀/a₀. l is the distance between the center of gravity GP_{L} of the left pupil and the center of gravity GP_{R} of the right pupil. Note that the expression (1) is satisfied with respect to the axis of the optical system. A relational expression with respect to the outside of the axis is omitted for convenience of explanation.

It is necessary to separately acquire the left-pupil image I_{L} and the right-pupil image I_{R} in order to calculate the phase difference s. The left-pupil image I_{L} and the right-pupil image I_{R} may be separately acquired in various ways. For example, a red-pass optical filter is provided at the left pupil position, and a blue-pass optical filter is provided at the right pupil position. A red image obtained by the image sensor is separated as the left-pupil image, and a blue image obtained by the image sensor is separated as the right-pupil image. Alternatively, the left-pupil image and the right-pupil image are separately acquired using the angle of light that enters the image sensor plane (see JP-A-2009-145401). Alternatively, parallax stereo images that correspond to the left-pupil image and the right-pupil image are separately acquired using a binocular camera. These methods may be selectively used corresponding to the intended use (objective) and the application.

It is important to increase the z resolution in order to implement an accurate 3D measurement process. The following expression (2) is obtained by transforming the expression (1) so that the z resolution Δz is represented using the phase difference resolution Δs.

$$Δ z = \frac{- Δ s}{Ml + Δ s} \qquad ( 2 )$$

As is clear from the expression (2), it is necessary to decrease the z resolution Δz by decreasing the phase difference resolution Δs in order to improve the measurement resolution in the z-direction. Specifically, it is necessary to more finely detect the phase difference between the left-pupil image and the right-pupil image in order to increase the z resolution Δz. It is necessary to increase the sampling density of the left-pupil image and the right-pupil image using the image sensor in order to more finely detect the phase difference between the left-pupil image and the right-pupil image. However, the sampling density is limited by the pixel pitch of an image sensor, and the pixel pitch of an image sensor has approached the limit It is difficult to further reduce the pixel pitch of an image sensor.

### 2.2. Imaging Device

FIG. 3 illustrates a configuration example of the imaging device according to the first embodiment. The imaging device includes an imager 10, a densification processing section 20 (densification measurement development section), a phase difference detection section 30, an optical characteristic memory 40, a ranging calculation section 80, and a three-dimensional shape output processing section 90. Note that the same elements as those described above are indicated by the same reference signs (symbols), and description thereof is appropriately omitted.

The imager 10 includes an optical low-pass filter 11, an imaging lens 12 (imaging optical system), a pupil division filter 13, an image sensor 14, and an imaging processing section 15.

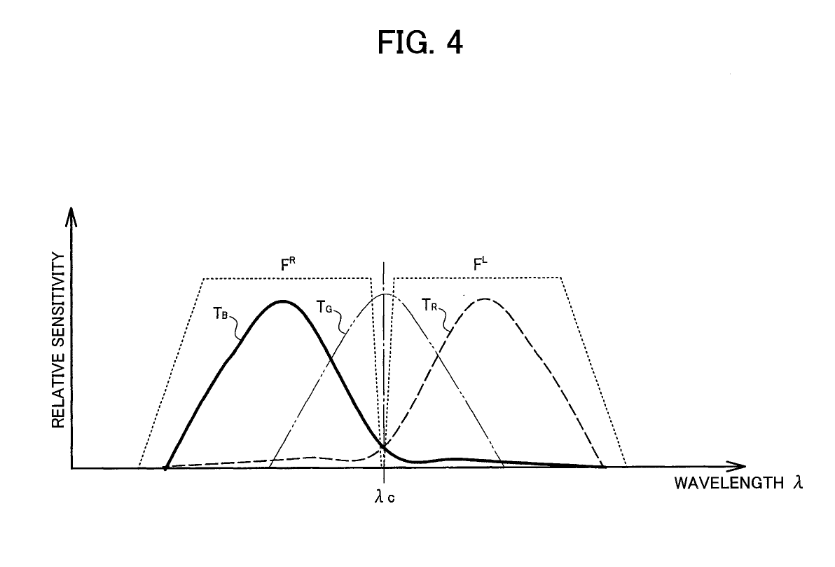

An R (red) filter is provided to the left pupil of the pupil division filter 13, and a B (blue) filter is provided to the right pupil of the pupil division filter 13. The image sensor 14 is an RGB color image sensor having a Bayer pixel array. FIG. 4 illustrates the spectral characteristics of the pupil division filter 13 and the image sensor 14. F^{L} indicates the spectral characteristics of the left-pupil R filter, and F^{R} indicates the spectral characteristics of the right-pupil B filter. T_{B}, T_{G}, and T_{R} indicate the spectral characteristics of the B pixel, the G (green) pixel, and the R pixel, respectively. The pupil spectral characteristics F^{L} and F^{R} are divided at the cross point (wavelength λc) of the spectral characteristics T_{B} of the B pixel and the spectral characteristics T_{R} of the R pixel, and cover the entire RGB band. The spectral characteristics F^{L} and F^{R} are designed to allow the G component (part of the G component) to pass through.

Note that the spectral characteristics {T_{B}, T_{G}, T_{R}} are defined as composite spectral characteristics of the characteristics of the color filters provided to the image sensor 14 on a pixel basis, the spectral characteristics of external light or illumination light applied to the object, and the spectral characteristics of each pixel. The parameters regarding the spectral characteristics are setting values (corresponding values) with respect to the wavelength λ. Note that the notation of the wavelength λ used as a dependent variable is omitted.

Reflected light from the object passes through the imaging lens 12, the pupil division filter 13, and the optical low-pass filter 11, and forms an image on the image sensor 14. In this case, a component value calculated by multiplying the spectral characteristics of the reflected light from the object by the left-pupil spectral characteristics F^{L} and the spectral characteristics T_{R} of the R pixel is obtained as the pixel value of the R pixel. Likewise, a component value calculated by multiplying the spectral characteristics of the reflected light from the object by the right-pupil spectral characteristics F^{R} and the spectral characteristics T_{B} of the B pixel is obtained as the pixel value of the B pixel. Specifically, the left-pupil image is obtained by the R image included in the Bayer image, and the right-pupil image is obtained by the B image included in the Bayer image.

The imaging processing section 15 controls the imaging operation, and processes an imaging signal. For example, the imaging processing section 15 converts the pixel signal from the image sensor 14 into digital data, and outputs Bayer-array image data (RAW image data).

The densification processing section 20 performs the sampling density densification process for detecting the phase difference between the R image and the B image at a resolution smaller (lower) than the sampling pixel pitch. The densification process increases the sampling density by a factor of N×N. Note that N is 100 to 10,000, for example. The details of the densification process are described later.

Note that the densification processing section 20 may perform a high-accuracy separation process on the R image and the B image based on the spectral characteristics F^{R}, F^{L}, T_{G}, and T_{R} stored in the optical characteristic memory 40. For example, the spectral characteristics T_{B} of the B pixel also have a component within the band of the left-pupil spectral characteristics F^{L}. Therefore, the B image (right-pupil image) includes the left-pupil component mixed therein. The densification processing section 20 may perform a process that reduces such a right pupil-left pupil mixed state based on the spectral characteristics F^{R}, F^{L}, T_{B}, T_{G}, and T_{R}.

The phase difference detection section 30 includes a phase difference rough detection section 50, a detectable area extraction section 60 (detectable feature part extraction section), and a phase difference fine detection section 70.

The phase difference rough detection section 50 performs the phase difference detection process that is lower in density than the phase difference detection process performed by the phase difference fine detection section 70. For example, the phase difference rough detection section 50 performs a correlation calculation process on the image that has been subjected to the densification process or the Bayer image that has not been subjected to the densification process in a state in which the pixels are thinned out.

The detectable area extraction section 60 determines whether or not a phase difference can be detected based on the correlation coefficient from the phase difference rough detection section 50, determines whether or not the distance information in the z-direction can be acquired based on the determination result, and outputs an image of the detectable area to the phase difference fine detection section 70. For example, the detectable area extraction section 60 determines whether or not a phase difference can be detected by determining whether or not a correlation peak is present.

The phase difference fine detection section 70 performs the phase difference detection process on the image that has been subjected to the densification process to finely detect the phase difference at a resolution smaller than the sampling pixel pitch. The phase difference fine detection section 70 performs the phase difference detection process on the area for which it has been determined by the detectable area extraction section 60 that a phase difference can be detected.

The ranging calculation section 80 calculates the distance in the z-direction at a high resolution based on the phase difference detected by the phase difference fine detection section 70. The three-dimensional shape output processing section 90 generates three-dimensional shape data based on the distance information in the z-direction, and outputs the generated three-dimensional shape data.

### 2.3. Densification Process

The sampling density densification process is described in detail below.

The right-pupil image and the left-pupil image (R pupil image and B pupil image) that have passed through the optical low-pass filter 11 are sampled by the color image sensor 14. The R pixels and the B pixels are arranged in the image sensor 14 as illustrated in FIG. 5. The optical low-pass filter 11 is an anti-aliasing filter, and is provided so that folding noise does not occur in the R pupil image and the B pupil image. Since the sampling pitch of each pupil image is 2p, the sampling frequency is 1/(2p), and the cut-off frequency is set to be equal to or lower than the Nyquist frequency (1/(4p)) determined corresponding to the sampling frequency.

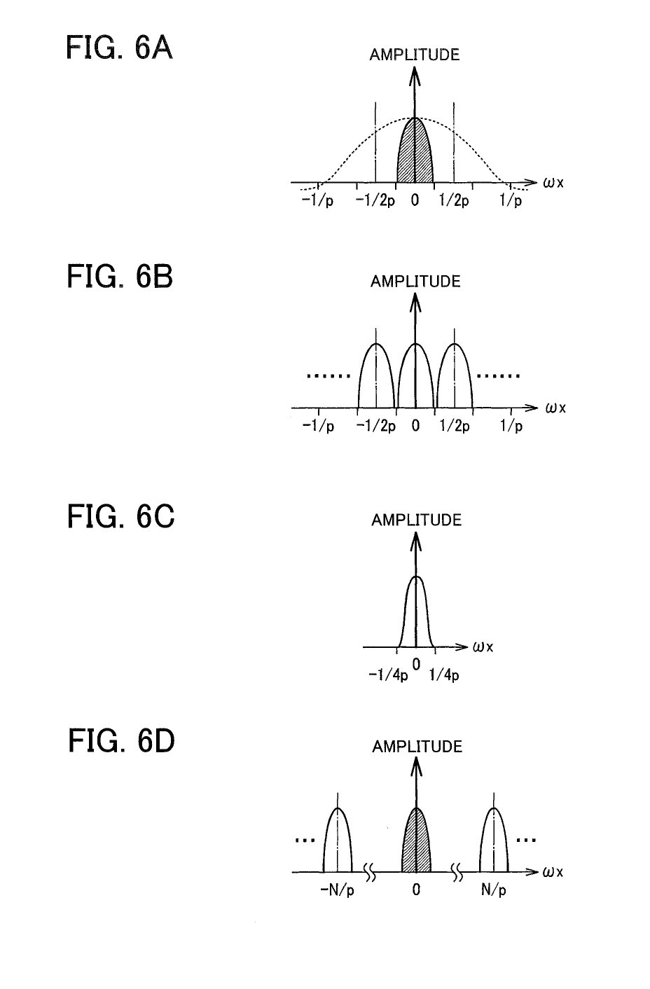

FIG. 6A illustrates the frequency characteristics of the R image and the B image. Specifically, when the frequency characteristics of the optical LPF are represented by 1/(4p), for example, the R image and the B image have a band within the range from −1/(4p) to +1/(4p). The repetition cycle is 1/(2p) (not illustrated in FIG. 6A). Note that the dotted line represents the frequency characteristics of the pixel aperture. The pixel aperture has a band within the range from −1/p to +1/p corresponding to the aperture width p.

Next, data is generated so that each sampling pixel of the R pupil image and the B pupil image obtained by the image sensor 14 includes micro-pixels (apparent pixels) that have a size equal to or smaller than that of one pixel. For example, when generating the pixel values sampled using pixels having a size 1/10^{th} of that of one pixel in the vertical direction and the horizontal direction, one pixel is equally divided into ten areas (N=10) in the vertical direction and the horizontal direction so that one pixel includes one hundred (N×N=100) micro-pixels. The pixel value of the original pixel is used as the pixel value of each micro-pixel. The above upsampling process is performed on each R pixel and each B pixel.

FIG. 6B illustrates the frequency characteristics of the resulting R image and the resulting B image. Since each pixel is merely divided, and the data is merely duplicated, the frequency characteristics are the same as those before the upsampling process is performed. Specifically, the R image and the B image have a band within the range from −1/(4p) to +1/(4p), and the repetition cycle is 1/(2p), for example.

The sampling data formed by the micro-pixels is filtered using a two-dimensional low-pass filter, and the micro-pixels (including pixels in an undetected area) over the entire captured image are reconstructed. Specifically, image data having a pixel pitch of p/N (p=pixel pitch of image sensor 14) is generated to obtain an N-fold sampling density (apparent sampling density). The cut-off frequency of the two-dimensional low-pass filter is set to be equal to or lower than the Nyquist frequency (1/(4p)) that is determined by the R or B sampling pitch 2p in the same manner as the optical low-pass filter. The two-dimensional low-pass filter is a Gaussian filter, for example.

The two-dimensional low-pass filter has the frequency characteristics illustrated in FIG. 6C, for example. The R image and the B image that have been subjected to the two-dimensional low-pass filtering process have the frequency characteristics illustrated in FIG. 6D, for example. The repetition frequency changes to N/p since the pixel pitch has changed to p/N. The band of the R image and the B image corresponds to a band calculated by multiplying the frequency characteristics of the optical low-pass filter by the frequency characteristics of the two-dimensional low-pass filter.

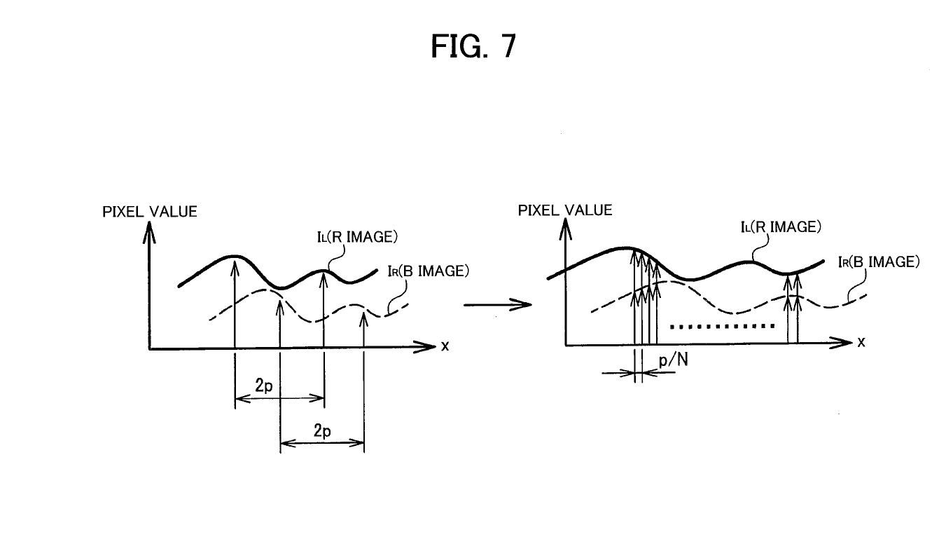

The left-pupil image (R pupil image) I_{L} and the right-pupil image (B pupil image) I_{R} before being subjected to the densification process are images sampled at a pitch of 2p (see the left side in FIG. 7). The left-pupil image (R pupil image) I_{L} and the right-pupil image (B pupil image) I_{R} that have been subjected to the densification process are obtained as image data sampled at a density (pitch: p/N) that is significantly higher than the sampling density of the image sensor 14 (see the right side in FIG. 7).

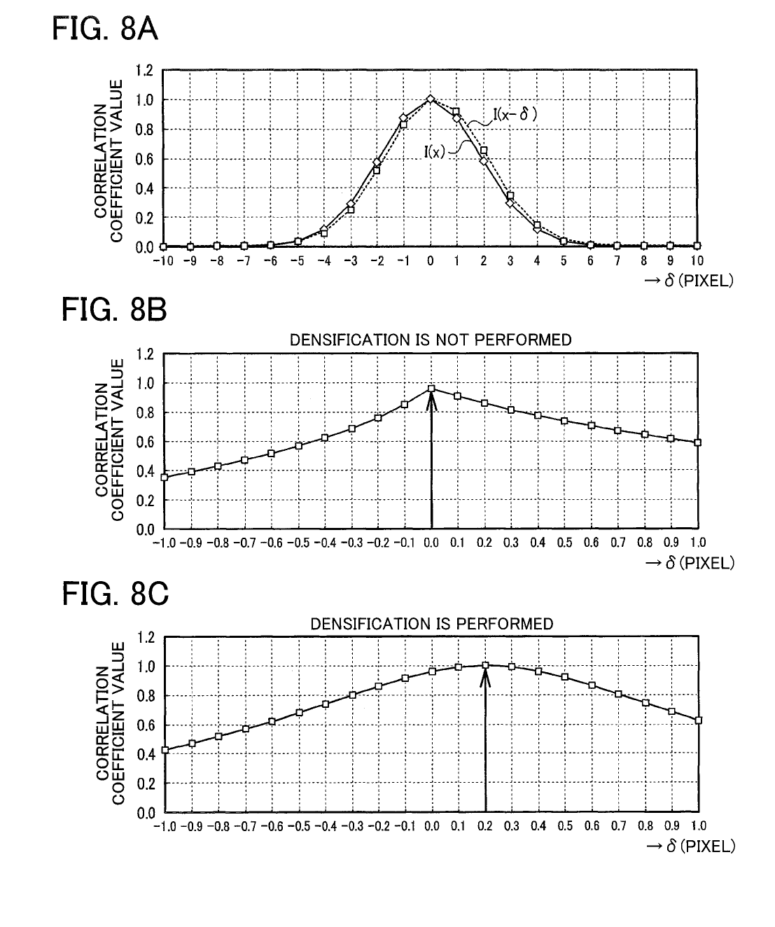

FIGS. 8A to 8C illustrate the simulation results for the phase difference detection process using the densification process. The horizontal axis indicates the shift amount (pixels) from the initial position “0” used for the correlation calculation process.

FIG. 8A illustrates a waveform for calculating the phase difference. When the pixel pitch of the image sensor is p, the waveform I(x) and the waveform I(x−δ) have a phase difference δ of 0.2 p (waveforms sampled at a pixel pitch of p).

FIG. 8B illustrates the simulation results when the sampling waveform I(x) and the sampling waveform I(x−δ) are merely upsampled (0.1p) (i.e., one pixel is divided on a 0.1p basis, and the pixel value of the pixel is duplicated), and the cross-correlation coefficient is calculated (shift: 0.1p). The correlation peak should be detected at δ=0.2p. However, since the sampling waveform has only a value on a pixel basis, the correlation peak is observed at δ=0 (i.e., detection at a resolution equal to or lower than one pixel is not achieved).

FIG. 8C illustrates the simulation results when the densification process according to the first embodiment is performed on the sampling waveform I(x) and the sampling waveform I(x−δ), and the cross-correlation coefficient is calculated. Specifically, FIG. 8C illustrates the simulation results when the low-pass filter having a cut-off frequency equal to or lower than 1/(4p) is applied after the upsampling process, and the cross-correlation coefficient is calculated (shift: 0.1p). A clear correlation peak is observed at δ=0.2p (i.e., a resolution of 0.1p is achieved).

Specifically, it is possible to achieve a phase difference detection resolution equal to or smaller than the pixel pitch of the image sensor by performing the upsampling process and the two-dimensional low-pass filtering process according to the first embodiment.

When using a normal phase difference detection process, the similarity between the left-pupil image (R pupil image) sampling data and the right-pupil image (B pupil image) sampling data deteriorates due to the difference in sampling position. The method according to the first embodiment can solve this problem. This feature is described below with reference to FIG. 9.

As illustrated in FIG. 9 (see the left side), the left-pupil image (R pupil image) I_{L} and the right-pupil image (B pupil image) I_{R} have an approximately identical waveform, and have a phase difference δ. The right side in FIG. 9 illustrates a state in which the waveform of the pupil image I_{L} and the waveform of the pupil image I_{R} are caused to overlap each other. In this case, the pupil image I_{L} and the pupil image I_{R} are matched, and it is desirable that the correlation coefficient at a position at which the waveforms have the highest similarity be obtained.

However, since the parallax δ is arbitrary, the R pixel sampling position and the B pixel sampling position normally differ from each other with respect to the pupil image I_{L} and the pupil image I_{R} that have an approximately identical waveform. Therefore, even when the left-pupil image (R pupil image) I_{L} and the right-pupil image (B pupil image) I_{R} are optically identical, different sampling data is obtained (i.e., the similarity is lost), for example. This means that it is impossible to calculate the correct position when calculating the matching position of the pupil image I_{L} and the pupil image I_{R} from the correlation coefficient.

For example, when the correlation coefficient is calculated while shifting the pupil image I_{L} and the pupil image I_{R} by one sampling pixel (i.e., at a pitch of 2p), the correlation coefficient is obtained at each position at which the pixel of the pupil image I_{L} and the pixel of the pupil image I_{R} (i.e., solid arrow and dotted arrow) coincide with each other. Specifically, the correlation coefficient when the waveforms coincide with each other is not obtained when the pupil image I_{L} and the pupil image I_{R} differ in sampling position, and a phase difference detection error occurs.

According to the first embodiment, since the high-density sampling data of the pupil image I_{L} and the pupil image I_{R} can be obtained (see the right side in FIG. 7), it is possible to ensure that the sampling data have similarity, and improve the phase difference detection accuracy. Moreover, since the noise component superimposed on the R pupil image I_{L} and the B pupil image I_{R} is reduced by applying the two-dimensional low-pass filtering process, it is possible to suppress or reduce a variation in matching position detection error due to noise.

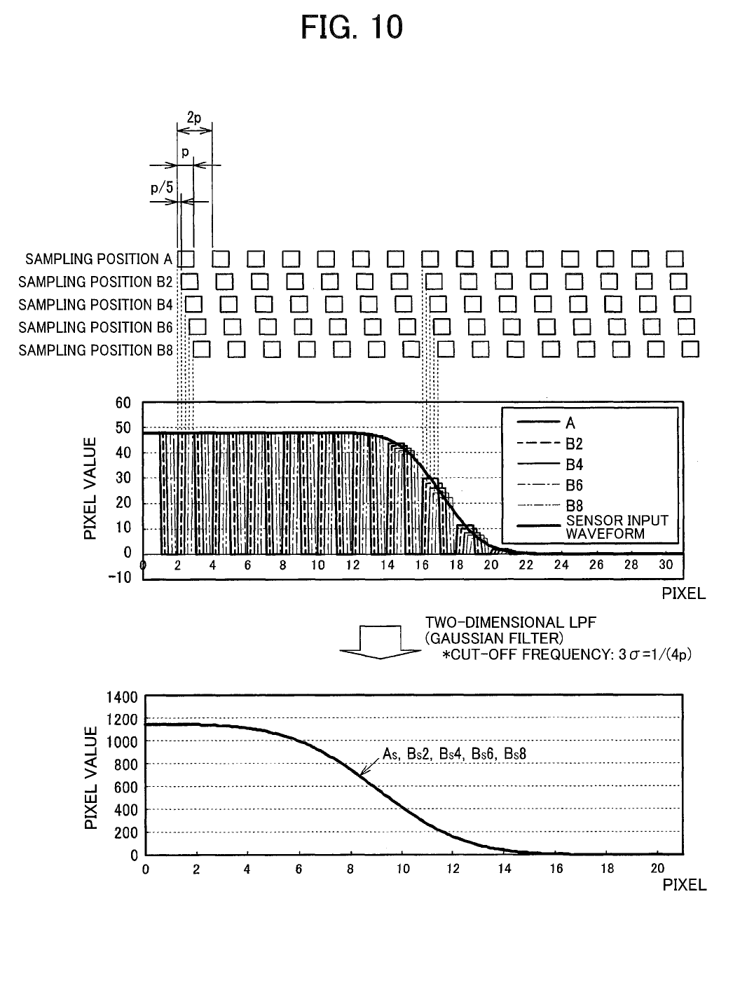

FIG. 10 illustrates the sampling data similarity simulation results. The upper part in FIG. 10 illustrates the sampling position. The sampling positions B2, B4, B6, and B8 are positions that are sequentially shifted from the sampling position A by 0.2p. For example, when the phase difference is 0.6p, the left-pupil image is sampled at the sampling position A, and the right-pupil image is sampled at the sampling position B6.

The middle part in FIG. 10 illustrates the sampling data. The sampling data represents data obtained by sampling the sensor input waveform at the sampling positions A, B2, B4, B6, and B8. The sensor input waveform is the waveform of the object image formed in the sensor plane. In this case, the similarity between the sampling data is low due to the difference in sampling position.

The lower part in FIG. 10 illustrates the results obtained by subjecting the sampling data to the densification process according to the first embodiment. The waveform data As, Bs2, Bs4, Bs6, and Bs8 correspond to the sampling positions A, B2, B4, B6, and B8. The waveform data As, Bs2, Bs4, Bs6, and Bs8 coincide with each other, and cannot be distinguished from each other (i.e., the similarity between the sampling data is high). It is possible to implement a highly accurate phase difference detection process by utilizing the sampling data having high similarity.

According to the first embodiment, the imager 10 includes the imaging optical system (imaging lens 12), the pupil division filter 13 that divides the pupil of the imaging optical system into a first pupil (left pupil) that allows the first object image to pass through, and a second pupil (right pupil) that allows the second object image to pass through, and the image sensor 14 that captures the first object image and the second object image formed by the imaging optical system.

According to this configuration, it is possible to capture parallax images using the monocular imager 10. It is possible to implement a high-resolution ranging process even using a monocular system by subjecting the parallax images to the densification process. Specifically, it is necessary to increase the pupil-to-pupil center-of-gravity distance l in order to increase the resolution Δz of the ranging process (see the expression (2)). However, it is difficult to increase the pupil-to-pupil center-of-gravity distance l when using a monocular system as compared with the case of using a binocular system. According to the first embodiment, however, since the phase difference detection resolution Δs can be increased by utilizing the densification process, it is possible to implement a high-resolution ranging process even when the pupil-to-pupil center-of-gravity distance l is short (see the expression (2)). For example, a reduction in the diameter of a scope is desired for an endoscope. It is possible to easily implement a reduction in the diameter of a scope when using a monocular system, and it is possible to implement a highly accurate ranging process by utilizing the densification process even when the pupil-to-pupil center-of-gravity distance l has decreased due to a reduction in the diameter of the scope.

According to the first embodiment, the image sensor 14 is an image sensor having a primary-color Bayer array. The pupil division filter 13 includes a filter that corresponds to the first pupil and allows light within a wavelength band that corresponds to red to pass through (spectral characteristics F^{L} illustrated in FIG. 4), and a filter that corresponds to the second pupil and allows light within a wavelength band that corresponds to blue to pass through (spectral characteristics F^{R} illustrated in FIG. 4). The densification processing section 20 (processor) performs the densification process on a red image and a blue image included in a Bayer-array image captured by the image sensor 14, the red image being the first image (left-pupil image), and the blue image being the second image (right-pupil image).

This makes it possible to implement a high-resolution phase difference detection process using a color image sensor having a primary-color Bayer array that is widely used. Since the parallax images can be formed by merely inserting the pupil division filter 13, and extracting the R image and the B image, it is possible to implement a high-resolution phase difference detection process without changing a known imager to a large extent. Since only the pupil division filter 13 is additionally provided to the optical system, it is possible to use the imager 10 having a compact configuration, and implement an endoscope having a small diameter (see above), for example.

According to the first embodiment, when the pixel pitch of the image sensor 14 is referred to as p, the pitch of the red pixels used to capture the first object image and the pitch of the blue pixels used to capture the second object image are P=2p. The cut-off frequency of the optical low-pass filter 11 is equal to or lower than 1/(2P)=1/(4p).

When implementing a normal capture operation without using the pupil division technique, the Nyquist frequency that corresponds to the pixel pitch p of the image sensor is 1/(2p), and the cut-off frequency of the optical low-pass filter 11 is set to be equal to or lower than 1/(2p). According to the first embodiment, since the sampling process is performed on each parallax image, the cut-off frequency of the optical low-pass filter 11 is set to be equal to or lower than the Nyquist frequency 1/(4p) that corresponds to the sampling pitch 2p. This makes it possible to suppress or reduce the occurrence of folding noise in the parallax images.

According to the first embodiment, the densification processing section 20 (processor) performs the upsampling process that divides each pixel of the first image and the second image into N×N pixels, and duplicates the pixel value of the original pixel to the N×N pixels.

According to the first embodiment, the cut-off frequency of the two-dimensional low-pass filtering process is equal to or lower than 1/(2P).

It is possible to provide data that includes micro-pixels by dividing each pixel of the parallax images into N×N pixels, and duplicating the pixel value of the original pixel. It is possible to generate the parallax images (as if the sampling process were performed using the micro-pixels) by subjecting the data to the two-dimensional low-pass filtering process using a cut-off frequency equal to or lower than 1/(2P). Since the frequency band of the parallax image is limited to be equal to or lower than 1/(2P) due to the optical low-pass filter 11, it is possible to reduce noise outside the band while allowing the component of the parallax image to remain by setting the cut-off frequency of the two-dimensional low-pass filter to be equal to or lower than 1/(2P).

### 3. Second Embodiment

A second embodiment of the invention is described below. In the second embodiment, the object is captured using a complementary-color image sensor, and a high-density left-pupil image and a high-density right-pupil image are generated from the resulting complementary-color image. Note that the imaging device is configured in the same manner as described above in connection with the first embodiment.

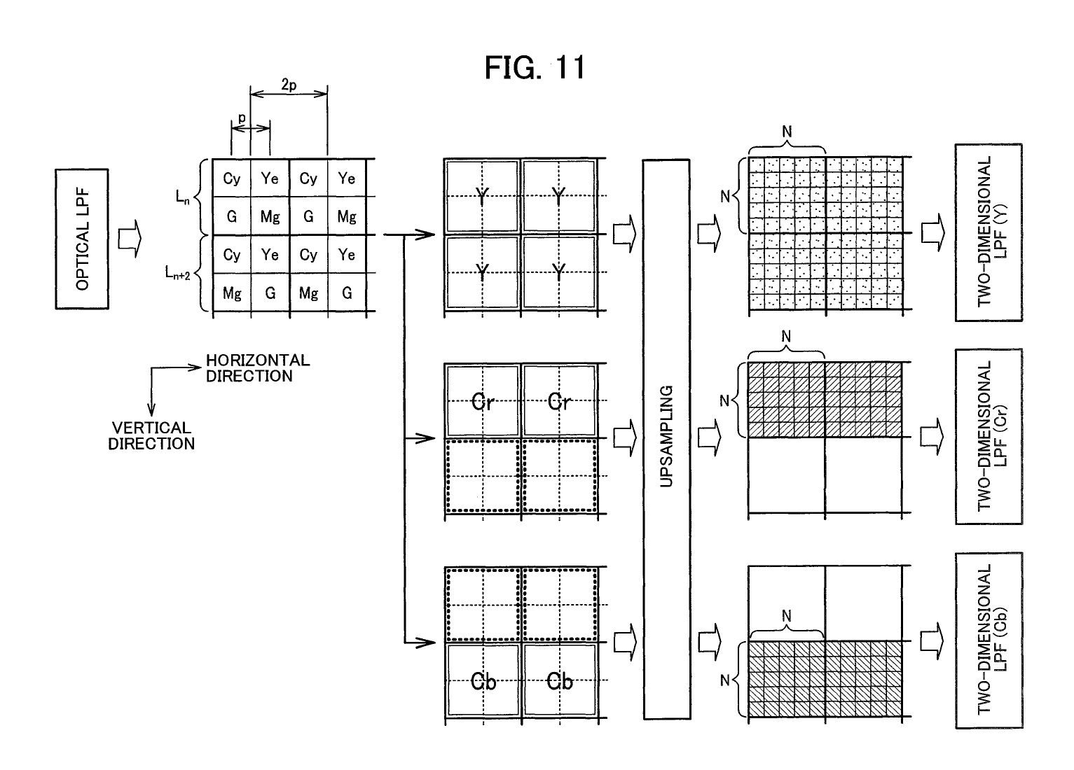

As illustrated in FIG. 11, the complementary-color image sensor includes a cyan (Cy=B+G) pixel, a magenta (Mg=B+R) pixel, a yellow (Ye=G+R) pixel, and a green (G) pixel. These pixels are normally arranged as illustrated in FIG. 11. When the pixel pitch is referred to as p, the arrangement pitch of each color is 2p.

The values read from the image sensor are values (combined values) obtained by combining (adding) the pixel values of two pixels that are adjacent to each other in the vertical direction. These combined values are referred to as A1, A2, B1, and B2 (see the following expression (3)).

$$\begin{matrix}{L}_{n} \text{:} A 1 = Cy + G , & A 2 = Ye + Mg \\ {L}_{n + 2} \text{:} B 1 = Cy + Mg , & B 2 = Ye + G\end{matrix} \} \qquad ( 3 )$$

The horizontal lines are formed on a 2-pixel basis. For example, a line Lₙ and a line Lₙ₊₂ (see FIG. 11) are sequentially formed in the vertical direction. The data represented by the expression (3) is output on a line basis. When using an interlace method, the data that corresponds to the line Lₙ and the data that corresponds to the line Lₙ₊₂ are read in an odd-numbered frame, and the data that corresponds to the line Lₙ₊₁ and the data that corresponds to the Lₙ₊₃ (i.e., shifted by one pixel in the vertical direction) are read in an odd-numbered frame. The process is described below taking the line Lₙ and the line Lₙ₊₂ as an example.

The brightness value Y and the color difference value Cr or Cb are calculated on a line basis (on a 4-adjacent pixel basis) using the combined values {A1, A2, B1, B2} (see the expression (3)) (see the following expression (4)).

$$\begin{matrix}{L}_{n} \text{:} Y = ( A 1 + A 2 ) / 2 , & Cr = A 2 - A 1 \\ {L}_{n + 2} \text{:} Y = ( B 1 + B 2 ) / 2 , & Cb = B 2 - B 1\end{matrix} \} \qquad ( 4 )$$

As illustrated in FIG. 11, the brightness value Y is calculated every line, and the color difference values Cr and Cb are calculated every other line. The brightness value Y and the color difference values Cr and Cb are values that correspond to four adjacent pixels. The four adjacent pixels are hereinafter referred to as “second pixel unit”.

The pitch of the second pixel unit in the horizontal direction at which the color difference values Cr and Cb are obtained is 2p, and the pitch in the vertical direction is 4p. Therefore, the cut-off frequency of the optical low-pass filter is set to be equal to or lower than the Nyquist frequency (1/(8p)) that is determined by the sampling pitch 4p (rough sampling pitch). The cut-off frequency of the two-dimensional low-pass filter is set in the same manner as the optical low-pass filter.

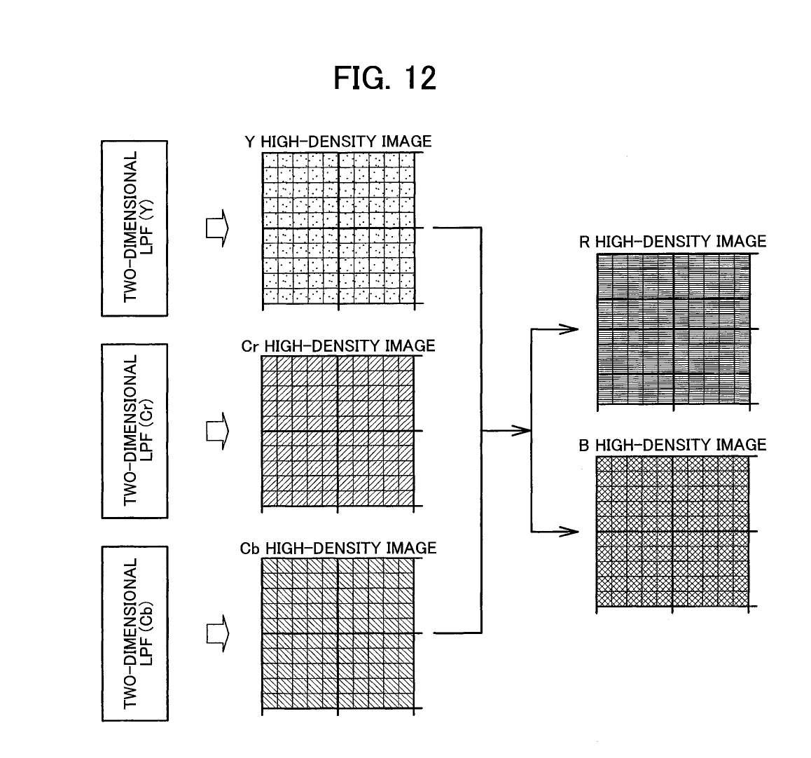

The second pixel unit (that corresponds to each of the brightness value Y and the color difference values Cr and Cb) is divided into N×N pixels, and the data of the original second pixel unit is duplicated to the N×N pixels in the same manner as described above in connection with the first embodiment. The image that includes the micro-pixels that are arranged equally is subjected to the two-dimensional low-pass filtering process. As illustrated in FIG. 12, a Y image, a Cr image, and a Cb image (apparently) sampled at a pitch of 2p/N are obtained by the two-dimensional low-pass filtering process.

The Y data, the Cr data, and the Cb data (that are represented using the micro-pixels arranged at high density) that have been subjected to the two-dimensional low-pass filtering process are converted into RGB data to calculate a high-density (2p/N pitch) R image and a high-density (2p/N pitch) B image that respectively correspond to the left-pupil image and the right-pupil image, and the phase difference is calculated from the high-density R image and the high-density B image. In the second embodiment, since the left-pupil image and the right-pupil image are respectively assigned to R and B, it is unnecessary to use the G image obtained by conversion for the phase difference detection process. Therefore, the primary color conversion process need not be performed with respect to G.

Since the left-pupil image and the right-pupil image are represented by the high-density image data, it is possible to calculate the phase difference at high resolution, and significantly improve the measurement resolution in the z-direction. According to the second embodiment, the image sensor 14 is a complementary-color image sensor. The pupil division filter 13 includes a filter that corresponds to the first pupil and allows light within a wavelength band that corresponds to red to pass through (spectral characteristics F^{L} illustrated in FIG. 4), and a filter that corresponds to the second pupil and allows light within a wavelength band that corresponds to blue to pass through (spectral characteristics F^{R} illustrated in FIG. 4). The densification processing section 20 (processor) generates a red image and a blue image from the image captured by the image sensor 14, and performs the densification process on the red image and the blue image, the red image being the first image (left-pupil image), and the blue image being the second image (right-pupil image).

This makes it possible to implement a high-resolution phase difference detection process using a complementary-color image sensor that is widely used. Since the parallax images can be formed by merely inserting the pupil division filter 13, and generating the R image and the B image from the YCrCb image, it is possible to implement a high-resolution phase difference detection process without changing a known imager to a large extent. Since the complementary-color image sensor has high sensitivity, it is possible to obtain parallax images having a good S/N ratio even when bright illumination is not obtained (e.g., endoscope (see above)), for example.

### 4. Third Embodiment

A third embodiment of the invention is described below. In the third embodiment, an improved sum of absolute differences (SAD) matching evaluation process is performed. It is possible to effectively implement a more accurate phase difference detection process by combining the third embodiment with the first or second embodiment. Note that the imaging device is configured in the same manner as described above in connection with the first embodiment. The phase difference fine detection section 70 performs the phase difference detection process according to the third embodiment. The phase difference rough detection section 50 performs a known SAD matching evaluation process, for example.

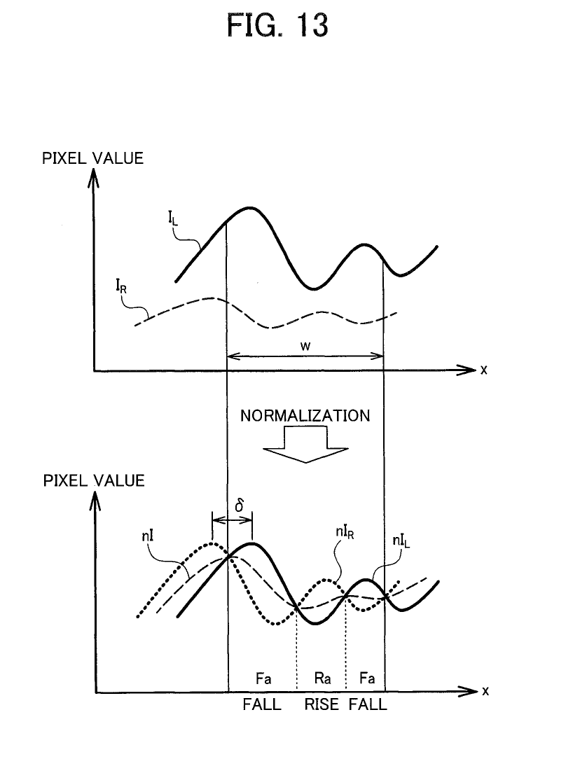

FIG. 13 is a view illustrating the improved SAD matching evaluation process.

I_{L} indicates the partial profile (waveform pattern) of the captured left-pupil image, and I_{R} indicates the partial profile (waveform pattern) of the captured right-pupil image. Specifically, I_{L} and I_{R} indicate the pixel value patterns of the parallax images (formed on the image sensor by light that has passed through the left pupil and light that has passed through the right pupil) in the horizontal direction x (parallax direction). The pupil image I_{L} and the pupil image I_{R} have a phase difference 6.

Since the pupil image I_{L} and the pupil image I_{R} differ in amplitude gain, a normalization process is performed using the value within a given calculation interval w (interval used to calculate the matching evaluation coefficient) to adjust the amplitude gain A normalized pupil image nI_{L} and a normalized pupil image nI_{R} are calculated by the following expression (5). Note that “w” attached to the sigma notation represents that the sum is calculated within the range of the given calculation interval w.

$${nI}_{R} = \frac{{I}_{R}}{\sqrt{{\sum }^{w} {I}_{R}^{2}}} , \\ {nI}_{L} = \frac{{I}_{L}}{\sqrt{{\sum }^{w} {I}_{L}^{2}}} \qquad ( 5 )$$

The normalized pupil image nI_{L} and the normalized pupil image nI_{R} are added up to generate a composite waveform nI (see the following expression (6)).

nI=nI_{R}+nI_{L} (6)

The cross points of the pupil image nI_{L} and the pupil image nI_{R} is detected within the given calculation interval w, and the interval between the adjacent cross points is calculated. An interval in which the composite waveform nI has a tendency to rise is referred to as “rise interval Ra”, and an interval in which the composite waveform nI has a tendency to fall is referred to as “fall interval Fa” For example, the differential value between the adjacent pixels of the composite waveform nI within the interval defined by the adjacent cross points is integrated, and the interval is determined to be the rise interval when the integral value is positive, and determined to be the fall interval when the integral value is negative.

A subtractive value D is calculated corresponding to the rise interval Ra and the fall interval Fa while changing the order of subtraction of the pupil image I_{L} and the pupil image I_{R} (see the following expression (7)). Specifically, the order of subtraction is determined so that “subtractive value D>0” in each interval.

$$\begin{matrix}Ra \text{:} {nI}_{R} > {nI}_{L} & ∴ D = {nI}_{R} - {nI}_{L} > 0 \\ Fa \text{:} {nI}_{R} < {nI}_{L} & ∴ D = {nI}_{L} - {nI}_{R} > 0\end{matrix} \} \qquad ( 7 )$$

The calculated subtractive values D are added within the given calculation interval w (see the following expression (8)) to calculate an ISAD evaluation value (matching evaluation coefficient). Note that “Ra” and “Fa” attached to the sigma notation represents that the sum is calculated corresponding to each of the ranges Ra and Fa within the given calculation interval w. When no cross point is present within the given calculation interval w, whether the given calculation interval w is the rise interval or the fall interval is determined, and the ISAD evaluation value is calculated corresponding to the given calculation interval w.

$$ISAD = {\sum }^{Ra} ( {nI}_{R} - {nI}_{L} ) + {\sum }^{Fa} ( {nI}_{L} - {nI}_{R} ) \qquad ( 8 )$$

In the third embodiment, whether each interval is the rise interval or the fall interval is determined, and the sum of difference is calculated for the pupil image I_{L} and the pupil image I_{R} for the following reasons instead of calculating the sum of absolute difference for the pupil image I_{L} and the pupil image I_{R} (known SAD method) without determining whether each interval is the rise interval or the fall interval. Note that the normalized waveform is also hereinafter referred to as “I_{L}”, “I_{R}”, or the like.

Suppose that the waveform patterns I_{L} and I_{R} are waveform patterns having very high similarity. A waveform obtained by adding a noise component n_{L} to the waveform pattern I_{L} is referred to as I_{L}′, and a waveform obtained by adding a noise component n_{R} to the waveform pattern I_{R} is referred to as I_{R}′ (see the following expression (9)).

$$\begin{matrix}{I}_{L}^{′} + {I}_{L} + {n}_{L} \\ {I}_{R}^{′} + {I}_{R} + {n}_{R}\end{matrix} \} \qquad ( 9 )$$

The following expression (10) represents the case where a known SAD matching evaluation process is applied to the waveform I_{L}′ and the waveform I_{R}′.

$$\begin{matrix}SAD = {\sum }^{w} \vert {I}_{R}^{′} - {I}_{L}^{′} \vert \\ = {\sum }^{w} \vert ( {I}_{R} - {I}_{L} ) + ( {n}_{R} - {n}_{L} ) \vert \leq {\sum }^{w} \{ \vert {I}_{R} - {I}_{L} \vert + \vert {n}_{R} - {n}_{L} \vert \}\end{matrix} \qquad ( 10 )$$

The SAD evaluation value becomes 0 when the comparison target waveforms coincide with each other. However, the SAD evaluation value has a value obtained by calculating the sum of the sum of absolute differences between the waveform I_{L} and the waveform I_{R} and the sum of absolute differences between the noise component n_{R} and the noise component n_{L} as the maximum value (see the expression (10)). The noise component n_{R} and the noise component n_{L} may be random noise. Since the absolute value is used, the noise component n_{R} and the noise component n_{L} do not counterbalance each other even when added up. This means that the SAD evaluation value includes a large amount of noise component even when the waveform I_{L} and the waveform I_{R} coincide with each other (i.e., |I_{L}−I_{R}|=0). Specifically, since the SAD evaluation value does not necessarily becomes a minimum even when |I_{L}−I_{R}|=0, it is impossible to determine the correct matching position. Therefore, the SAD evaluation value is very easily affected by noise.

On the other hand, the relationship represented by the following expression (11) is obtained by applying the expression (9) to the ISAD evaluation value defined by the expression (8).

$$\begin{matrix}ISAD = {\sum }^{Ra} \{ ( {I}_{R} + {n}_{R} ) - ( {I}_{L} + {n}_{L} ) \} + {\sum }^{Fa} \{ ( {I}_{L} + {n}_{L} ) - ( {I}_{R} + {n}_{R} ) \} \\ = {\sum }^{w} \vert {I}_{R} - {I}_{L} ) + {\sum }^{w} ( {n}_{R} - {n}_{L} )\end{matrix} \qquad ( 11 )$$

The ISAD evaluation value is calculated by calculating the sum of the sum of absolute differences between the waveform I_{L} and the waveform I_{R} and the sum of differences between the noise component n_{R} and the noise component n_{L}. The sum of absolute differences between the waveform I_{L} and the waveform I_{R} becomes 0 (|I_{L}−I_{R}|=0) when the waveform I_{L} and the waveform I_{R} coincide with each other. The sum of differences between the noise component n_{R} and the noise component n_{L} decreases due to the effect of addition of random noise since the absolute value is not used. The sign of the difference between the noise components differs between the interval Ra and the interval Fa, but does not affect the effect of addition since the noise component is random noise. Therefore, the matching position of the waveform I_{L} and the waveform I_{R} can be evaluated using the ISAD evaluation value in a state in which noise is significantly reduced. Specifically, the ISAD evaluation value makes it possible to implement a matching evaluation process that is not easily affected by noise, and the ISAD evaluation method is superior to the SAD evaluation method.

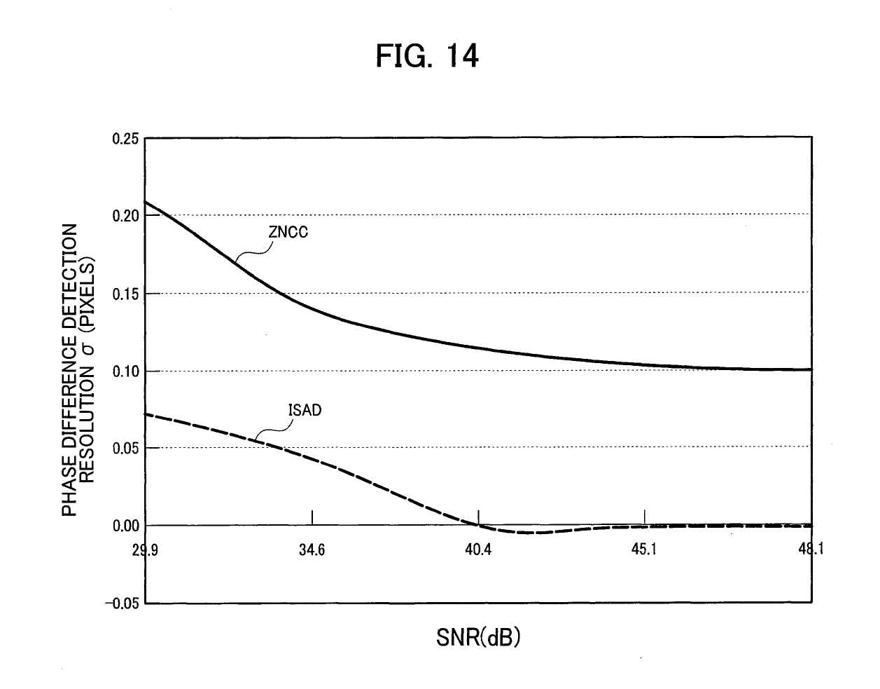

FIG. 14 illustrates the simulation results for the statistical variance σ of the phase difference detection value with respect to the SN ratio (SNR) of the waveform I_{L}′ and the waveform I_{R}′.

An edge waveform is used as the waveform I_{L}′ and the waveform I_{R}′. The phase difference when the matching evaluation value becomes a maximum (peak value) is used as the phase difference detection value. The variance σ is calculated as described below. Specifically, the waveform I_{L}′ and the waveform I_{R}′ are generated while randomly changing the appearance pattern of noise having an identical power.

The matching process is performed a plurality of times using the waveform I_{L}′ and the waveform I_{R}′ to calculate the phase difference. An error between the phase difference and the true value of the phase difference between the waveform I_{L} and the waveform I_{R} is calculated, and the variance σ is calculated from the distribution of the occurrence of the error.

FIG. 14 also illustrates the variance σ when using a correlation coefficient calculated using a known zero-mean normalized cross-correlation (ZNCC) method. It is obvious that the error variation σ of the phase difference detection value when using the ISAD evaluation value is smaller than the error variation σ of the phase difference detection value when using the ZNCC evaluation value with respect to the same SN ratio. Specifically, the ISAD evaluation value is not easily affected by noise, and achieves high phase difference detection resolution.

For example, when the correlation calculation process is performed on low-frequency images, a variation in correlation peak increases if a degradation factor such as noise is applied, and the phase difference detection accuracy deteriorates. According to the third embodiment, however, since the variation σ in correlation peak is small as compared with the case of using a known method even when noise is applied, it is possible to implement a highly accurate phase difference detection process.

The embodiments to which the invention is applied and the modifications thereof have been described above. Note that the invention is not limited to the above embodiments and the modifications thereof. Various modifications and variations may be made without departing from the scope of the invention. A plurality of elements described in connection with the above embodiments and the modifications thereof may be appropriately combined to implement various configurations. For example, some elements may be omitted from the elements described in connection with the above embodiments and the modifications thereof. Arbitrary elements among the elements described in connection with different embodiments or modifications thereof may be appropriately combined. Specifically, various modifications and applications are possible without materially departing from the novel teachings and advantages of the invention. Any term cited with a different term having a broader meaning or the same meaning at least once in the specification and the drawings can be replaced by the different term in any place in the specification and the drawings.

What is claimed is:

1. An imaging device comprising:
an imager that captures a first object image and a second object image that have parallax with respect to an identical object; and
a processor comprising hardware,
the processor being configured to implement:
a densification process that is performed on a first image and a second image, the first image being an image in which the first object image is captured, and the second image being an image in which the second object image is captured; and
a phase difference detection process that detects a phase difference between the first image and the second image that have been subjected to the densification process,
wherein the imager includes an optical low-pass filter that has a cut-off frequency equal to or lower than 1/(2P) when a pitch of pixels that are used to capture the first object image and a pitch of pixels that are used to capture the second object image are P, and
the processor is configured to implement the densification process that includes performing an upsampling process on the first image and the second image, and performing a two-dimensional low-pass filtering process on the first image and the second image that have been subjected to the upsampling process.

2. The imaging device as defined in claim 1,
wherein the imager includes:
an imaging optical system;
a pupil division filter that divides a pupil of the imaging optical system into a first pupil that allows the first object image to pass through, and a second pupil that allows the second object image to pass through; and
an image sensor that captures the first object image and the second object image formed by the imaging optical system.

3. The imaging device as defined in claim 2,
wherein the image sensor is an image sensor having a primary-color Bayer array,
the pupil division filter includes a filter that corresponds to the first pupil and allows light within a wavelength band that corresponds to red to pass through, and a filter that corresponds to the second pupil and allows light within a wavelength band that corresponds to blue to pass through, and
the processor is configured to implement the densification process on a red image and a blue image included in a Bayer-array image captured by the image sensor, the red image corresponding to the first image, and the blue image corresponding to the second image.

4. The imaging device as defined in claim 3,
wherein, when a pixel pitch of the image sensor is referred to as p, a pitch of red pixels used to capture the first object image and a pitch of blue pixels used to capture the second object image are P=2p, and
a cut-off frequency of the optical low-pass filter is equal to or lower than 1/(4p).

5. The imaging device as defined in claim 2,
wherein the image sensor is a complementary-color image sensor,
the pupil division filter includes a filter that corresponds to the first pupil and allows light within a wavelength band that corresponds to red to pass through, and a filter that corresponds to the second pupil and allows light within a wavelength band that corresponds to blue to pass through, and
the processor is configured to implement the densification process on a red image and a blue image generated from an image captured by the image sensor, the red image corresponding to the first image, and the blue image corresponding to the second image.

6. The imaging device as defined in claim 1,
wherein the processor is configured to implement the densification process that includes performing the upsampling process that divides each pixel of the first image and the second image into N×N pixels, and duplicates a pixel value of an original pixel to the N×N pixels.

7. The imaging device as defined in claim 1,
wherein a cut-off frequency of the two-dimensional low-pass filtering process is equal to or lower than 1/(2P).

8. The imaging device as defined in claim 1,
wherein the processor is configured to implement the densification process that includes performing a process that virtually decreases a sampling pitch of the first object image and the second object image.

9. A phase difference detection method comprising:
capturing a first object image and a second object image that have parallax with respect to an identical object, the first object image and the second object image having passed through an optical low-pass filter having a cut-off frequency equal to or lower than 1/(2p) when a pitch of pixels that are used to capture the first object image and a pitch of pixels that are used to capture the second object image are P;
performing an upsampling process on a first image and a second image, the first image being an image in which the first object image is captured, and the second image being an image in which the second object image is captured;
performing a two-dimensional low-pass filtering process on the first image and the second image that have been subjected to the upsampling process; and
detecting a phase difference between the first image and the second image that have been subjected to the two-dimensional low-pass filtering process.
